(19) United States
(12) Patent Application Publication
(10) Pub. No.: US 2019/0191666 A1
(43) Pub. Date: Jun. 27, 2019

(54) APPARATUS FOR ORIENTING AND DIRECTING CATTLE

(71) Applicant: Eric Amos, Rushville, IN (US)

(72) Inventor: Eric Amos, Rushville, IN (US)

(21) Appl. No.: 16/267,783

(22) Filed: Feb. 5, 2019

Related U.S. Application Data
(60) Provisional application No. 62/637,113, filed on Mar. 1, 2018.

(51) Int. Cl. A01K 1/062; A01K 15/04

(52) U.S. Cl. CPC A01K 1/062; A01K 15/04

(57) ABSTRACT

An apparatus for restricting animal movement, including a first major axis, first and second brackets, each having a respective fence-engaging portion, a respective elongated fence stabilizing portion connected to the fence-engaging portion and extending along the first major axis, a respective slot formed through the respective elongated fence stabilizing portion, and a respective elongated member extending from the first bracket, and at least one fastener connecting the first and second brackets to define a bracket assembly. The respective slots align to allow passage of the at least one fastener therethrough.

### CROSS REFERENCE TO RELATED APPLICATIONS

This patent application claims priority to U.S. Provisional Patent Application Ser. No. 62/637,113, filed on Mar. 1, 2018.

### TECHNICAL FIELD

This novel technology relates to the field of cattle fencing. More specifically, the present technology relates to a fence-mounted system for orienting and directing individual heads of cattle.

### BRIEF DESCRIPTION OF THE DRAWINGS

FIG. 1 is a first perspective view of a fence-mountable cattle directing and orienting assembly according to a first embodiment of the present novel technology.

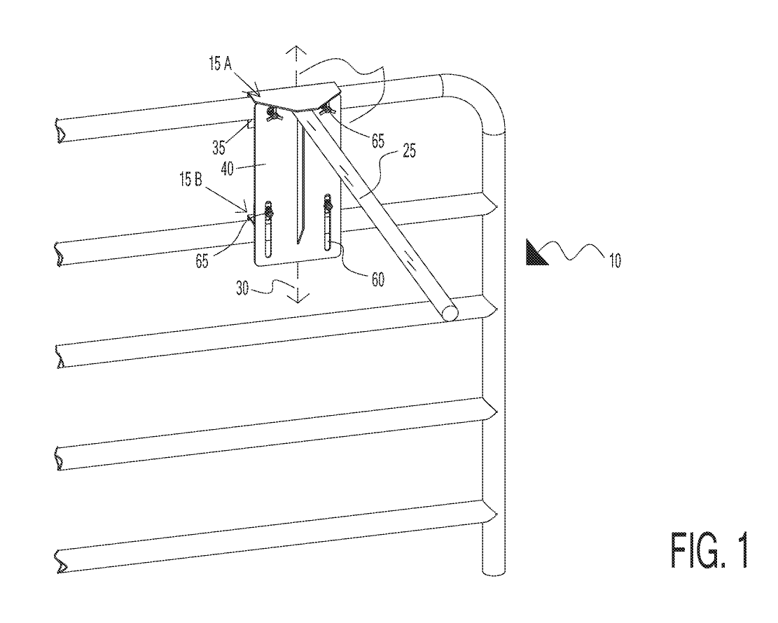

FIG. 2 is a second perspective view of the embodiment of FIG. 1.

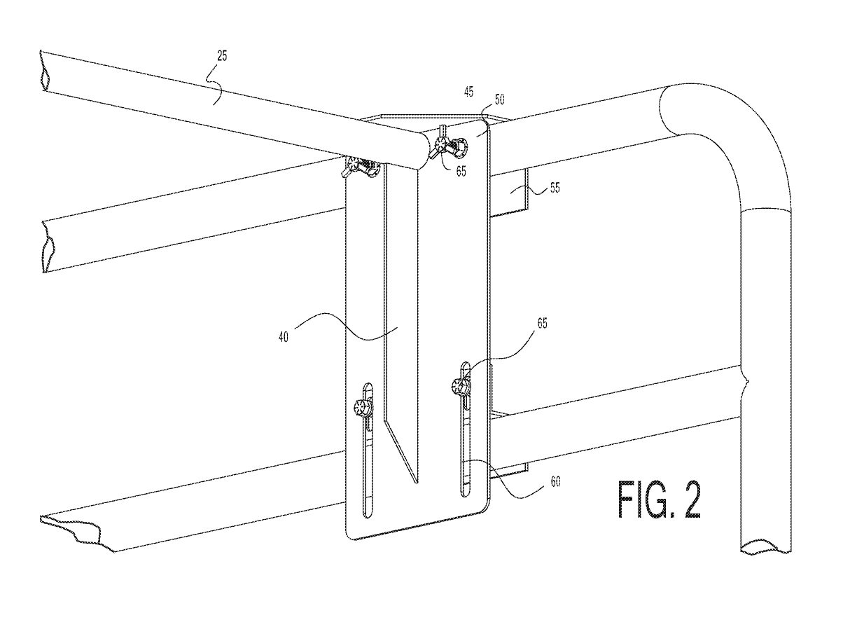

FIG. 3 is a third perspective view of the embodiment of FIG. 1.

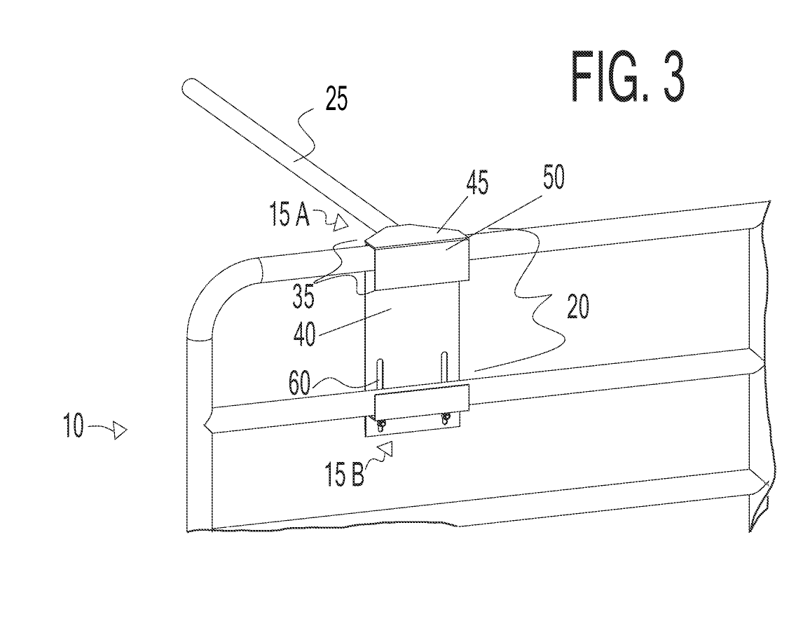

FIG. 4 is a fourth perspective view of the embodiment of FIG. 1.

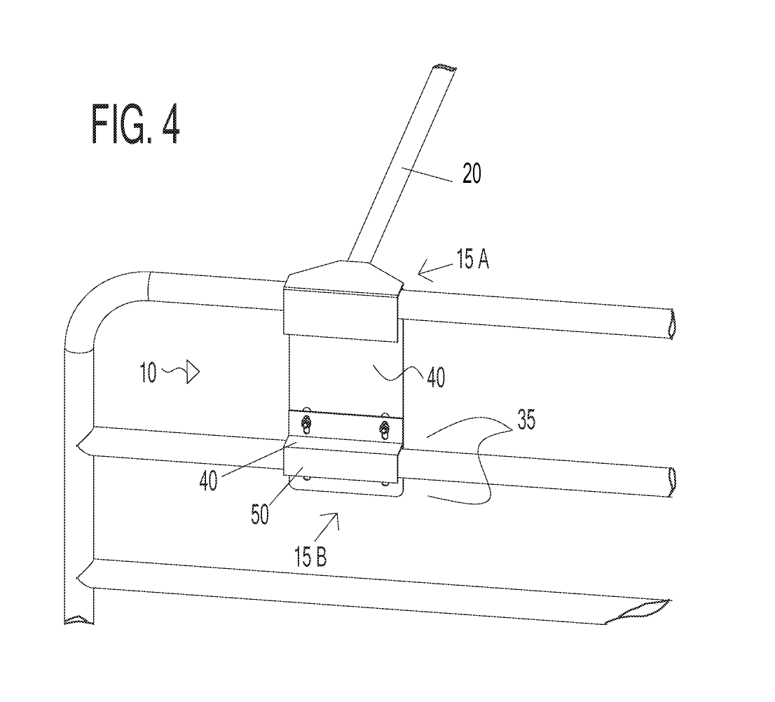

FIG. 5 is a perspective view of a second embodiment of the present novel cattle orientation technology.

FIG. 6 is a perspective view of a third embodiment of the present novel cattle orientation technology.

FIG. 7 is a first perspective view of a fourth embodiment of the present novel cattle orientation technology.

FIG. 8 is a second perspective view of the embodiment of FIG. 7 with the elongated cattle directing member oriented at an intermediate angle between the horizontal (perpendicular to the major axis)and the vertical (parallel to the major axis).

FIG. 9 is a third perspective view of the embodiment of FIG. 7 with the elongated cattle directing member oriented at a vertical angle (parallel to the major axis).

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not.

In one embodiment, the cattle directing and orienting apparatus or system 10 consists of at least one bracket assemblies, each assembly including at least one bracket 15, and more typically a pair of brackets 15 (such as top bracket 15A and bottom bracket 15B) defining a bracket assembly 20, from which an elongated member 25 (typically perpendicularly) extends. Each respective bracket 15 operationally connects to the other, and each respective bracket 15 likewise removably engages, or ‘hooks over’, standard horizontal fencing members, such as elongated horizontal pipe, square tubing, slats, or the like. A first axis 30 is defined by and extends between the brackets 15. The connection or engagement of bottom bracket 15B with top bracket is typically adjustable to fit any spacing between horizontal bars. An elongated rod or member extends 25 from at least one of the brackets 15 and/or the bracket assembly 20, the member 25 typically oriented perpendicularly to the bracket assembly 20 and to the fencing to which the assembly is, or may be, connected.

The elongated member 25 is typically made of a structural material, such as steel, aluminum, carbon fiber composite, or the like, although member 25 may be made from any convenient structural material. In some embodiments, elongated member 25 is an elongated rod having a circular cross section, and is permanently affixed to the top bracket 15A, such as by welding. In other embodiments, elongated member 25 is a length of hollow core square tubing and is pivotably connected to the top bracket 15A, such that elongated member may be positioned to extend horizontally from bracket assembly 15 (extending perpendicularly from axis 30), vertically from bracket assembly 15 (extending along axis 30), or held in one or more positions therebetween.

The primary or upper bracket 15A includes a H-shaped fence engaging portion 35, an elongated fence-engaging stabilization portion 40 extending therefrom and an elongated cattle-engaging member 25 extending therefrom and oriented generally perpendicular to the elongated stabilizing portion 40. The fence-engaging portion 35 may be an elongated plate, bar, rod, or the like, and the elongated cattle engaging portion 25, while typically a bar or rod, may likewise be a plate or like elongated member.

The typically H-shaped fence engaging portion 35 typically further includes a first or top elongated rectangular plate 45 from which at least one side plate 50, and more typically two generally parallel spaced side plates 50, 55 extend. Side plates 50, 55 are typically oriented perpendicular to top plate 45, and more typically extend from opposite ends of top plate 45. Side plate 55 may be unitary, or may be a portion of stabilizing member 40.

The elongated fence-engaging stabilization portion 40 is typically a plate or elongated member, and is more typically configured to matingly engage a second or lower bracket 15B. Elongated fence-engaging stabilization member may extend from side plate 55, or may simply be extended or elongated side plate 55. The second bracket 15B is matingly engagable with bracket 15A. Brackets 15 typically include one or more slots 6o formed therethrough and positioned to align when the brackets 15 are matingly engaged with one another. Fasteners 65, such as nut and bolt assemblies, are engagable through the aligned slots to hold brackets 15 together and in a particular alignment or orientation.

Second bracket 15B typically has the inverse configuration of bracket 15A, having a H-shaped fence engaging portion 35 and an elongated fence-engaging stabilization portion 40 extending therefrom. Second bracket 15B typically does not include an elongated member 25 extending therefrom, but could have the same in some desired embodiments.

Brackets 15 typically also include one or more (typically threaded) apertures formed through one or both side plates 50, 55, so that a threaded member or locking fastener 65, such as a bolt or screw, may be inserted therethrough to engage an elongated fence portion to which the bracket 15 has been connected to lockingly secure the bracket 15 to the fence member and retard or prevent sliding of the bracket 15 along the fence member.

In operation, the system 10 keeps cattle standing straight and oriented away from the fencing to which the system is or may be mounted, preventing the cattle from being able to travel from side to side. Such restriction of sideways movement protects nearby people, such as a handler, from being in harms way. One or more (typically two) bracket assemblies 20 are operationally connected to one or more horizontal fence members, such as by engaging the fence member(s) with the H-shaped fence engaging portion(s) 35 of the respective bracket(s) 15, and typically locking the bracket(s) 15 to the fence via insertion of the locking fastener(s) 65 through the aperture(s) 70. Typically, top and bottom brackets 15A, 15B are so engaged to two spaced fence members, and the brackets 15A, 15B then engaged to one another (or directly to the fencing) via insertion and tightening of fasteners 65 through aligned slots 6o.

The bracket assembly/assemblies 20 are positioned so that the elongated member 25 extends outwardly from the fence at about cattle shoulder height. Typically, two assemblies 20 are engaged to the fence and spaced slightly more than the width of the animal whose movement is intended to be restricted. The assemblies 20 may be operationally connected to the fence with the animal present, or the animal may be walked to the fence between the assemblies 20 once the assemblies so are connected to the fence. Adjustments to the positioning of a respective assembly 20 may be made by loosening the fastener(s) 65 allowing sliding of a respective bracket 15 from side to side and/or up and down relative to one another. Typically, there are no wrenches or tools required in mounting the system to a gate or fence, as the fasteners 65 may be hand-tightened to sufficiently affix the bracket system 10 to the fencing. The elongated member 25, such as pipe and/or square tubing, that is typically welded or otherwise affixed to the mounting plate 55 typically extends horizontally from the gate or fence to which the bracket assembly 20 has been mounted.

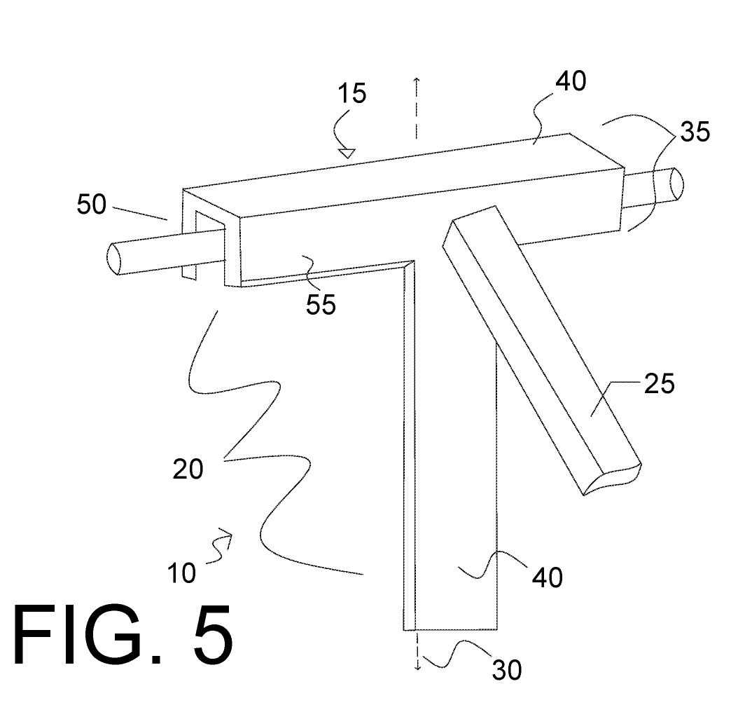

In some embodiments, such as illustrated in FIG. 5, the top bracket 15A includes an elongated fence-engaging stabilization plate or member 40 that extends sufficiently to flushly engage a second fence member below that to which the bracket 15A is mounted or mountable. Engagement of the elongated member 40 with the second fence member is sufficient to prevent pivoting of the fence engaging portion 35 about the fence member to which it is mounted or mountable, thus keeping the elongated member 25 positioned to horizontally extend from the fence. In these embodiments, the second bracket portion 15B is not required.

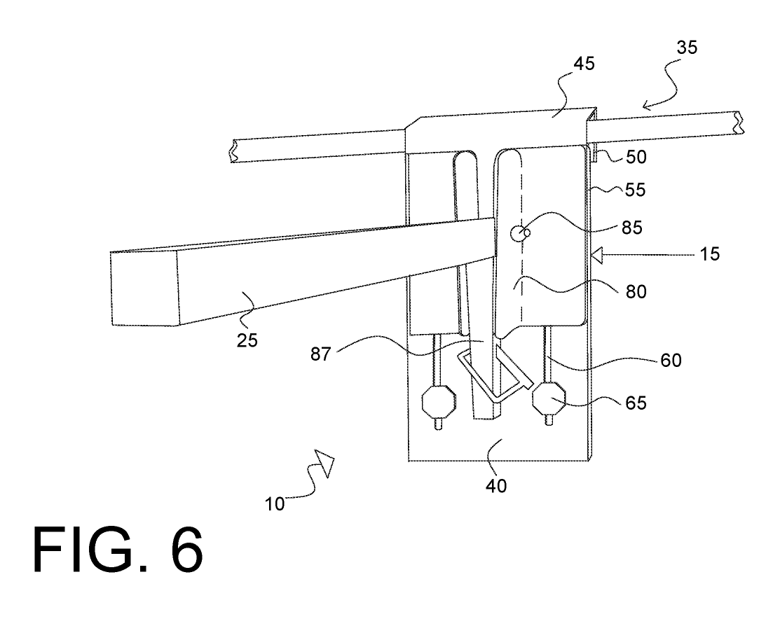

In some embodiments, such as illustrated in FIG. 6, one or more (typically a pair) front plates 8o are connected to and extend from side plate 55 adjacent to and, typically, flanking elongated member 25. In these embodiments, elongated member 25 may be fixedly connected to side plate 55, such as by welding, or may be connected to front plates 8o, either fixedly, such as by welding, or removably connectably, such as by insertion of one or more pins 85 through apertures 90 formed through front plate(s) 80. Elongated member 25 may pivot about pin 85, and be held in position by additional pins 85, a movable support member 87, or the like.

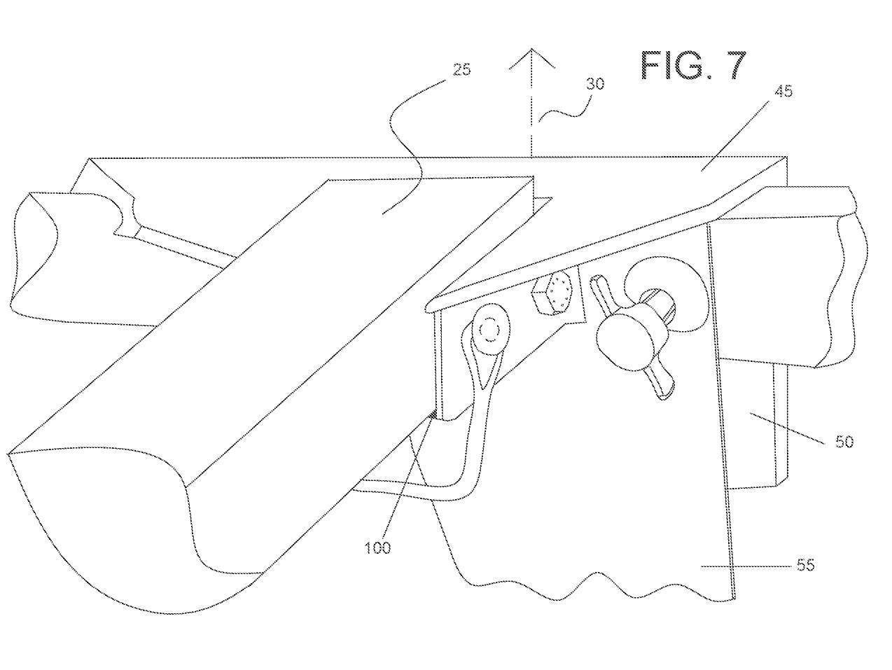

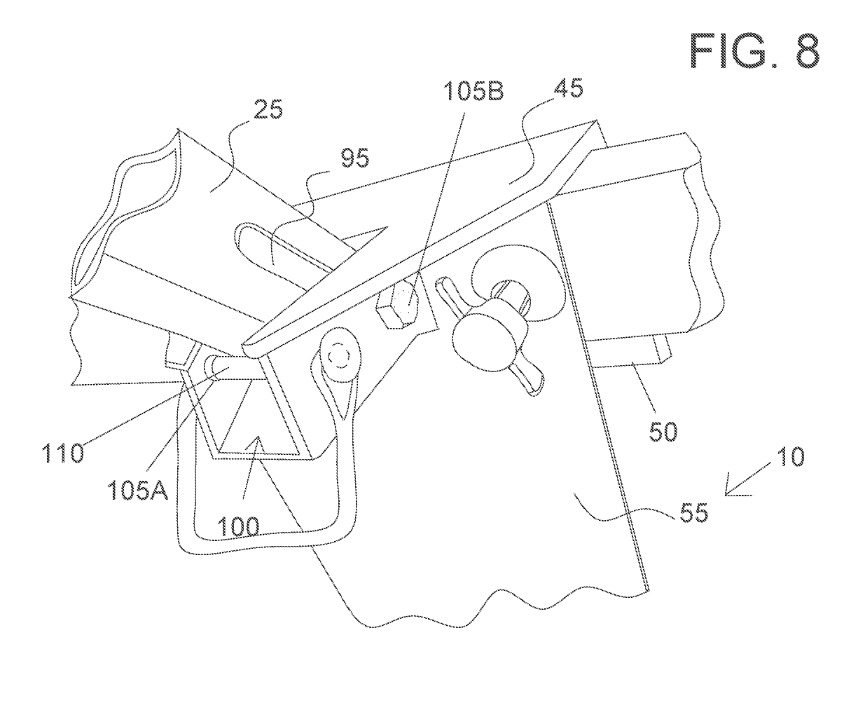

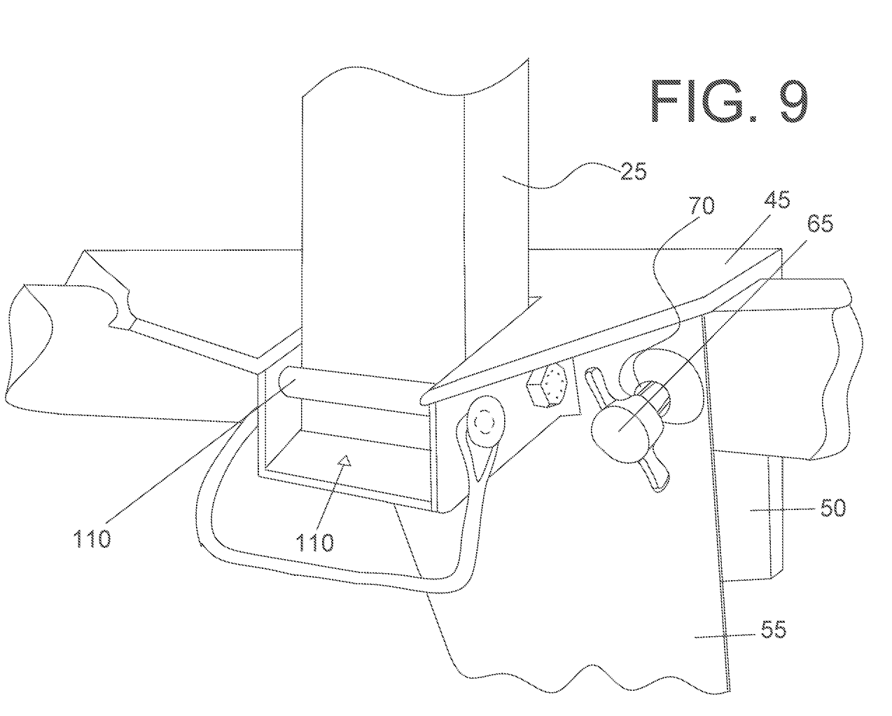

In some embodiments, as shown in FIGS. 7-9, elongated member 25 is a length of hollow core square tubing having a pair of oppositely disposed slots 95 formed trough one end for pivotably connecting to the top bracket 15A. In this embodiment, top bracket has a cradle 100 sized and shaped to receive slotted square tubing 25, with at least two pairs of oppositely disposed apertures 105A, 105B through which pins 110 may be inserted. Member 25 may pivot about pin 110 when inserted through apertures 105A and parallel slots 95, or may be restrained from pivoting by insertion of another pin no when inserted through apertures 105B and through slots 95. Pin 110 may also be inserted through apertures and slots 105B, 95 when member 25 is pivoted between the horizontal and vertical position to engage member 25 and hold it in an intermediate orientation between the horizontal and vertical. Finally, member 25 may be pivoted about pin 110 extending through slots and aperture 95, 105A to a vertical orientation, wherein member 25 may slide into recess 115 to lock member 25 into the vertical orientation.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

I claim:

1. An animal movement restraining device, comprising:
a first bracket for engaging a horizontal fencing member, wherein the first bracket assembly further comprises a first fence member engaging portion and a first stabilizing portion extending from the fence member engaging portion; and
an animal positioning member extending from the first bracket and oriented perpendicularly with the stabilizing portion.

2. The device of claim 1 wherein the stabilizing portion is a first slotted plate, the device further comprising:
a second bracket assembly matingly engagable to the first bracket assembly, wherein the second bracket assembly further comprises a second fence engaging member and a second slotted plate extending therefrom; and
at least one fastener for extension through the first and second slotted plates to connect the first bracket assembly to the second bracket assembly.

3. The device of claim 1 wherein the first stabilizing portion is an elongated member.

4. The device of claim 1 and further comprising a at least one plate extending from the bracket assembly and positioned adjacent the animal positioning member.

5. The device of claim 4 wherein the at least one plate is a pair of plates, each respective plate positioned on an opposing side of the animal positioning member positioned therebetween.

6. The device of claim 1 wherein the first fence member engaging portion is H-shaped, having a first elongated plate from which two spaced, parallel plates extend.

7. The device of claim 1 wherein the animal positioning member is pivotably connected to the first bracket.

8. An apparatus for restricting animal movement, comprising:
a first major axis;
a first bracket, further comprising:
a first fence-engaging portion;
a first elongated fence stabilizing portion connected to the fence-engaging portion and extending along the first major axis;
a first slot formed through the first elongated fence stabilizing portion;
a first elongated member extending from the first bracket;
a second bracket, further comprising:
a second fence-engaging portion;
a second elongated fence stabilizing portion connected to the fence-engaging portion and extending along the first major axis;
a second slot formed through the second elongated fence stabilizing portion;
at least one fastener connecting the first and second brackets to define a bracket assembly;
wherein the first and second slots align to allow passage of the at least one fastener therethrough.

9. The apparatus of claim 8 wherein each respective fence engaging portion is Π-shaped, having a first elongated plate from which spaced parallel second and third elongated plates extend.

10. The apparatus of claim 9 wherein each respective second elongated plate extends from each respective first elongated plate in the same direction.

11. The apparatus of claim 9 wherein each respective second elongated plate extends from each respective first elongated plate in an opposite direction.

12. The apparatus of claim 8 and further comprising at least one elongated plate member extending from the first bracket assembly, wherein the at least one elongated plate member is positioned adjacent to and spaced from the first elongated member.

13. The apparatus of claim 12 wherein the at least one elongated plate member is a pair of elongated plate members, wherein the first elongated member extends therebetween.

14. The apparatus of claim 8 wherein the first elongated member is pivotably connected to the first bracket and pivotably between a horizontal orientation extending perpendicularly from the first axis to a vertical position extending parallel to the first axis.
